(19) United States
(12) Patent Application Publication
(10) Pub. No.: US 2026/0261048 A1
(43) Pub. Date: Sep. 3, 2026

(54) ANTENNAS WITH AT LEAST ONE PIM SHIELD AND RELATED DEVICES

(71) Applicant: Outdoor Wireless Networks LLC, Richardson, TX (US)

(72) Inventors: Samantha L. Merta, Richardson, TX (US); Peter J. Bisiules, LaGrange Park, IL (US); Sammit Patel, Richardson, TX (US)

(21) Appl. No.: 19/162,146

(22) PCT Filed: Mar. 4, 2024
(86) PCT No.: PCT/US2024/018294

§ 371 Date: Sep. 4, 2025

Related U.S. Application Data
(60) Provisional application No. 63/493,361, filed on Mar. 31, 2023.

(51) Int. Cl. H01Q 15/00; H01Q 1/42; H01Q 21/08

(52) U.S. Cl. CPC H01Q 15/0013; H01Q 1/42; H01Q 21/08

(57) ABSTRACT

At least one PIM shield provided by a frequency selective surface that can be arranged in, on and/or about an active antenna that has mMIMO antenna array operating at a high band frequency range and radio unit that is configured to transmit signal through the FSS and out a front radome of the base station antenna. Even though the active antenna can be devoid of low band and mid-band radiating elements, the frequency selective surface can have a pattern unit/array of cells that block or reflect signal at low and mid-band and that allows signal at high band to propagate therethrough.

### RELATED APPLICATIONS

This application claims the benefit of and priority to U.S. Provisional Application Ser. No. 63/493,361, filed Mar. 31, 2023, the contents of which are hereby incorporated by reference as if recited in full herein.

### BACKGROUND

The present invention generally relates to radio communications and, more particularly, to base station antennas for cellular communications systems.

Cellular communications systems are well known in the art. In a cellular communications system, a geographic area is divided into a series of regions that are referred to as “cells” which are served by respective base stations. The base station may include one or more antennas that are configured to provide two-way radio frequency (“RF”) communications with mobile subscribers that are within the cell served by the base station. In many cases, each cell is divided into “sectors.” In one common configuration, a hexagonally shaped cell is divided into three 120° sectors in the azimuth plane, and each sector is served by one or more base station antennas. Each base station antenna includes one or more phase-controlled arrays of radiating elements that generate radiation patterns (also referred to herein as “antenna beams”). Typically, the base station antennas are mounted on a tower or other raised structure, with the antenna beams that are generated by the arrays of radiating elements directed outwardly.

In order to accommodate the increasing volume of cellular communications, cellular operators have added cellular service in a variety of new frequency bands. In order to increase capacity without further increasing the number of base station antennas, multi-band base station antennas have been introduced which include multiple linear arrays of radiating elements. Additionally, base station antennas are now being deployed that include “beamforming” arrays of radiating elements that include multiple columns of radiating elements that are connected to respective ports of a radio so that the antenna may perform active beamforming (i.e., the shapes of the antenna beams generated by the antenna may be adaptively changed to improve the performance of the antenna). In some cases, the radios for these beamforming arrays may be integrated into the antenna. These beamforming arrays typically operate in higher frequency bands, such as various portions of the 3.3-5.8 GHz frequency band. Antennas having integrated radios that can adjust the amplitude and/or phase of the sub-components of an RF signal that are transmitted through individual radiating elements or small groups thereof are referred to as “active antennas.” Active antennas can generate narrowed beamwidth, high gain, antenna beams and can steer the generated antenna beams in different directions by changing the amplitudes and/or phases of the sub-components of RF signals that are transmitted through the antenna.

Further details of example conventional antennas can be found in co-pending WO2019/236203 and WO2020/072880, the contents of which are hereby incorporated by reference as if recited in full herein.

Passive inter-modulation distortion (“PIM”) is a form of electrical interference that may occur when two or more RF signals encounter non-linear electrical junctions or materials along an RF transmission path. Such non-linearities may act like a mixer causing the RF signals to generate new RF signals at mathematical combinations of the original RF signals. These newly generated RF signals are referred to as “inter-modulation products.” If RF signals transmitted through a device generate inter-modulation products that fall in the same bandwidth of RF signals that are received through the same device, the inter-modulation products effectively increase the noise level experienced by the existing RF signals in the receiver bandwidth. When the noise level is increased, it may be necessary to reduce the data rate and/or the quality of service. PIM can be an important interconnection quality characteristic, as PIM generated by a single low-quality interconnection may degrade the electrical performance of the entire RF communications system. Thus, ensuring that components used in RF communications systems will generate acceptably low levels of PIM may be desirable.

The above-described inter-modulation products arise because non-linear systems generate harmonics in response to sinusoidal inputs. For example, when a signal having a first frequency Sri is input to a non-linear system, then the resulting output signal will include signals at integer multiples of the input frequency. When two or more signals having different frequencies are input to a non-linear system, inter-modulation products arise. For example, consider a composite input signal x(t) to a non-linear system that includes signals at three different frequencies:

$$x ( t ) = {A}_{1} sin ( 2 π {f}_{1} t + {φ}_{1} ) + {A}_{2} sin ( 2 π {f}_{2} t + {φ}_{2} ) + {A}_{3} sin ( 2 π {f}_{3} t + {φ}_{3} ) \qquad EQN ( 1 )$$

In Equation (1) above, Aᵢ and φᵢ are the amplitudes and phases of the signals at the three different frequencies f₁, f₂, f₃. If these signals are passed through a non-linearity, the resulting output signal will include components at the frequencies f₁, f₂, f₃ of the three input signals, which are referred to as the fundamental components, as well as linear combinations of these fundamental components having the form:

$$k 1 f 1 + k 2 f 2 + k 3 f 3 \qquad EQN ( 2 )$$

where k₁, k₂, k₃ are arbitrary integers which can have positive or negative values. These components are the inter-modulation products and harmonics and will have amplitudes and phases that are a function of the non-linearity and the composite input signal x(t).

The order of an inter-modulation product is the sum of the absolute value of the coefficients kᵢ included in the inter-modulation product. In the above example where the composite input signal x(t) includes signals at three different frequencies, the third order inter-modulation products are the inter-modulation products where:

$$\vert k 1 \vert + \vert k 2 \vert + \vert k 3 \vert = 3 , where \vert k 1 \vert , \vert k 2 \vert , \vert k 3 \vert < 3 \qquad EQN ( 3 )$$

In the above example, the third-order inter-modulation products will be at the following frequencies:

$$\begin{matrix}{f}_{1} + {f}_{2} - {f}_{3} \\ {f}_{1} + {f}_{3} - {f}_{2} \\ {f}_{2} + {f}_{3} - {f}_{1} \\ 2 {f}_{1} - {f}_{2} \\ 2 {f}_{1} - {f}_{3} \\ 2 {f}_{2} - {f}_{1} \\ 2 {f}_{2} - {f}_{3} \\ 2 {f}_{3} - {f}_{1} \\ 2 {f}_{3} - {f}_{2}\end{matrix}$$

The odd-order inter-modulation products are typically of the most interest as these products are the ones that tend to fall in the vicinity of the frequencies of the fundamental components.

PIM may be caused by, for example, inconsistent metal-to-metal contacts along an RF transmission path, particularly when such inconsistent contacts are in high current density regions of the transmission path such as inside RF transmission lines, inside RF components, or on current carrying surfaces of an antenna. Such inconsistent metal-to-metal contacts may occur, for example, because of contaminated and/or oxidized signal carrying surfaces, loose connections between two connectors, metal flakes or shavings inside RF components or connections and/or poorly prepared soldered connections (e.g., a poor solder termination of a coaxial cable onto a printed circuit board). PIM may arise in a variety of different components of an RF communications system. For example, non-linearities may exist at the interconnections in an RF communications system where cables such as coaxial cables are connected to each other or to RF equipment. PIM may also arise in other components of an RF communications system such as radios, RF amplifiers, duplexers, cross-band couplers, interference mitigation filters and the like. PIM may also arise on or within radiating elements of the RF communications system such as parabolic antennas or phased array antenna elements. The non-linearities that give rise to PIM may be introduced at the time of manufacture, during installation, or due to electro-mechanical shift over time due to, for example, mechanical stress, vibration, thermal cycling, and/or material degradation.

In the past, RF absorption materials have been placed behind a passive antenna to try to ameliorate PIM from surrounding structures and/or other antenna.

There is a need for alternative solutions to suppress PIM in noisy RF environments.

### SUMMARY

Embodiments of the present invention are directed to base station antennas with a PIM shield having a frequency selective surface (FSS).

The FSS can be configured to allow high band radiating elements to propagate electromagnetic waves therethrough and reflect lower band RF signals transmitted by lower band radiating elements.

The FSS can be provided, for example, by a flexible or conventional printed circuit board defining a metal grid pattern, a metallized film or tape having an FSS pattern thereon, a sheet(s) of metal provided with a grid pattern or a radome with a metal pattern(s) printed thereon to provide a metallized grid.

Aftermarket PIM shield kits can include metallized film or tape with adhesive providing FSS metallized patterns for ease of applying to components in the field.

PIM shield boxes or other structures can be provided that cover at least part of a rear surface of a base station antenna housing.

Active antennas can be manufactured with integrated FSS features to suppress PIM.

Embodiments of the present invention are directed to an active antenna that includes: a housing with a radome; a multi-column array of radiating elements in the housing; active antenna radio circuitry that is coupled to the multi-column array of radiating elements; and a passive inter-modulation distortion (“PIM”) shield that is on, in and/or positioned about at least part of the active antenna. The PIM shield has a frequency selective surface (FSS).

The FSS can be configured to reflect or block electromagnetic waves from radiating elements of a passive base station antenna that operates in one or more lower frequency bands while allowing higher frequency band electromagnetic waves of the active antenna to travel therethrough.

The FSS can be provided by a flexible film or tape comprising a metal pattern of unit cells and adhesive that is applied to the radome.

The FSS can be arranged to cover at least part of rearwardly extending sidewalls of the housing and the radome.

The FSS can be arranged to cover an outer front surface of the radome.

The FSS can be arranged to cover an inner surface of the radome.

The FSS can have a first pattern unit configuration at a first location and a second pattern unit configuration at a second location. The first pattern unit configuration is different than the second pattern unit configuration.

The PIM shield can have a longitudinally and laterally extending front that resides in front of the housing and provides the FSS.

The PIM shield can have right and left side walls that extend rearwardly about right and left side walls of the housing.

The right and left side walls can be metal and devoid of the FSS.

The right and left side walls can include the FSS.

The PIM shield can be a concealment shroud that surrounds the active antenna.

The active antenna can be spaced apart from a passive base station antenna.

The active antenna can project forward of the passive base station antenna.

The PIM shield can be provided by a box that at least partially encloses the active antenna housing.

The PIM shield can be provided by a box with at least one wall comprising the FSS and that at least partially encloses the radome.

The PIM shield can enclose the housing and optionally at least part of a pole attached to the active antenna.

The FSS can be provided, at least in part, by a sheet of metal arranged to provide a grid pattern of unit cells.

The FSS can have a metal pattern provided by a flexible film with an adhesive configured to attach to target surfaces of the active antenna housing.

Still other embodiments are directed to an (active) antenna that includes: a radome comprising a frequency selective surface (FSS) providing a passive intermodulation (PIM) shield; and an array of radiating elements facing the radome. The array of radiating elements is configured to propagate RF energy at a first frequency band through the FSS, and the FSS is configured to reflect, absorb and/or block RF energy at frequency bands lower than the first frequency band.

The FSS can be provided on an internal and/or external surface of the radome.

Yet other embodiments are directed to an antenna system that includes: a passive base station antenna having a front radome and a rear wall, a plurality of columns of first radiating elements configured for operating in a first operational frequency band, each column of first radiating elements comprising a plurality of first radiating elements arranged in a longitudinal direction, and a frequency selective surface (FSS) providing a passive intermodulation (PIM) shield residing across the rear of the base station antenna housing. The FSS is configured to reflect, absorb or block electromagnetic waves within the first operational frequency band and pass electromagnetic waves at a higher frequency band.

The FSS providing the PIM shield can also extend along right and left, longitudinally extending, sidewalls of the base station antenna housing.

The antenna system can further include an active antenna. The active antenna has a housing with a radome and can have a frequency selective surface (FSS) providing a PIM shield, and a plurality of columns of second radiating elements configured for operating in a second operational frequency band that is different from and does not overlap with the first operational frequency band. The second operational frequency band can be higher than the first operational frequency band, and the active antenna can be spaced apart from and offset from the passive base station antenna.

The FSS can be defined by a tape or film comprising a metal pattern of an array of unit cells and an adhesive.

The FSS providing the PIM shield of the passive base station antenna can be provided by a U-shaped structure (with the closed end being shorter than the legs with the free ends). The rear wall can be inside the U-shaped structure and an open end of the U faces the front radome of the passive base station antenna.

The FSS providing the PIM shield of the active antenna can have a U-shaped structure with the radome inside the U-shaped structure and an open end of the U facing a rear of the active antenna.

Still other embodiments are directed to a passive base station antenna that includes: a base station antenna housing with a front radome and a rear wall spaced apart from the front radome and extending between right and left sidewalls that are longitudinally extending sidewalls; a passive antenna assembly in the base station housing that includes a plurality of columns of first radiating elements residing in front of a reflector and configured for operating in a first operational frequency band; and a frequency selective surface (FSS) providing a passive intermodulation (PIM) shield residing across the rear of the base station antenna housing. The FSS is configured to reflect, absorb or block electromagnetic waves within the first operational frequency band. The right and left side walls have a metallized radome surface or reside adjacent longitudinally extending metal walls configured to reflect signal from the first operational frequency band from the plurality of first radiating elements back into the base station antenna housing.

Additional embodiments are directed to methods of suppressing passive intermodulation in a base station antenna having a passive antenna and a spaced apart active antenna. The methods include attaching a tape or film with adhesive and comprising a metal pattern of unit cells defining a frequency selective surface (FSS) to one or more of: an active antenna, a pole coupled to the active antenna, brackets attaching the active antenna to a mounting structure, a passive antenna, a mounting structure coupled to the passive antenna, or brackets attaching the passive antenna to the mounting structure.

The methods can include attaching the tape or film to the active antenna and the active antenna is spaced apart from the passive antenna whereby the applied tape or film with the FSS suppresses PIM caused by the position or operation of one or both of the active antenna or the passive antenna.

The attaching can be carried out at a field site for to an installed active antenna and/or passive antenna to suppress PIM and optionally the attaching can be carried out while the active antenna and/or passive antenna are operational thereby not requiring any downtime for installation.

The tape or film with the FSS can be configured to block or reflect low band RF energy and allow higher band energy to propagate therethrough.

The attaching is carried out to at least partially surround the active antenna with the tape or film.

Embodiments of the present invention are directed to a base station antenna that includes: a base station antenna housing with a front radome and a rear; a passive antenna assembly in the base station housing having plurality of linear arrays of radiating elements that extend in front of a reflector; and a passive inter-modulation distortion (“PIM”) shield structure that is provided to extend in, on or about an active antenna and/or about a passive antenna assembly. The PIM shield structure includes a frequency selective surface (FSS).

The FSS can be configured to reflect or block electromagnetic waves from radiating elements of the passive antenna assembly and allow higher band electromagnetic waves to travel therethrough toward the front radome.

An FSS can be applied to or integral with an active antenna.

The FSS can be configured to allow RF energy to pass through at one or more defined frequency range and reflect RF energy at a different frequency band.

The FSS can be configured to reflect RF energy at a low band and pass RF energy at a higher band.

The plurality of linear arrays can include low band dipole antennas.

The PIM shield structure can be provided as a box-like structure with an open front that is configured to extend along and across a rear of a base station antenna housing with a passive antenna assembly therein.

Embodiments of the present invention are directed to an antenna that includes: a housing with an external radome; a multi-column array of radiating elements in the housing; and a passive inter-modulation distortion (“PIM”) shield that is on, in and/or positioned about at least part of the housing, wherein the PIM shield comprises a frequency selective surface (FSS).

The FSS can be configured to reflect or block electromagnetic waves from radiating elements of a passive base station antenna that operates in one or more lower frequency bands while allowing higher frequency band electromagnetic waves of the active antenna to travel therethrough.

The PIM shield can have a first longitudinally extending body coupled to a second longitudinally extending body, and the first and second longitudinally extending bodies can cooperate to define a plurality of longitudinally extending windows, with at least one of the windows configured to receive a mounting bracket. The first and second longitudinally extending bodies may each provide a bracket attachment projecting rearward adjacent at least one of the windows.

The PIM shield can have a rear wall with first and second laterally spaced apart and rearwardly extending projections that extend longitudinally along at least a portion of a length of the passive antenna thereby providing a maximum wind load reduction.

The antenna can include active antenna radio circuitry that is coupled to the multi-column array of radiating elements.

The FSS can be provided by a flexible film or tape comprising a metal pattern of unit cells and adhesive that can optionally be applied to the radome.

The antenna can be an active antenna and the FSS can be arranged to cover at least part of rearwardly extending sidewalls of the housing and the radome.

The antenna can be an active antenna and the FSS can be arranged to cover an outer front surface of the external radome.

The FSS can be arranged to cover an inner surface of the external radome.

The FSS can have a first pattern unit configuration at a first location and a second pattern unit configuration at a second location and the first pattern unit configuration is different than the second pattern unit configuration.

The antenna can be an active antenna comprising radio circuitry. The PIM shield can have a longitudinally and laterally extending front that resides in front of the housing and includes the FSS. The PIM shield can also have right and left sidewalls that extend rearwardly about right and left sidewalls of the housing.

The right and left sidewalls can be metal and devoid of the FSS.

The right and left sidewalls can also include the FSS.

The antenna can be an active antenna and the PIM shield can be a concealment shroud that surrounds the active antenna.

The antenna with the PIM shield can be an active antenna and is spaced apart from a passive base station antenna.

The active antenna can project forward of the passive base station antenna.

The PIM shield can be provided by a structure that at least partially encloses the housing.

The PIM shield can be provided by a box-like structure with a rear wall and left and right sidewalls with at least one of the walls comprising the FSS.

The PIM shield can at least partially enclose the radome.

The FSS can be provided, at least in part, by a sheet of metal arranged to provide a grid pattern of unit cells.

The FSS can be provided by a metal pattern provided by a flexible film with an adhesive configured to attach to target surfaces of housing.

Embodiments of the present invention include an antenna system with: a passive antenna having a front radome and a rear wall; a plurality of columns of first radiating elements configured for operating in a first operational frequency band, each column of first radiating elements comprising a plurality of first radiating elements arranged in a longitudinal direction; and a passive intermodulation (PIM) shield comprising a frequency selective surface (FSS) extending behind and across the rear wall for at least part of a length of the passive antenna. The FSS is configured to reflect, absorb or block electromagnetic waves within the first operational frequency band and pass electromagnetic waves at a higher frequency band.

The PIM shield can have right and left sidewalls that extend along corresponding right and left, longitudinally extending sidewalls of the passive antenna, and wherein the right and left sidewalls of the PIM shield project forward from the rear wall in a front-to-back direction of the passive antenna.

The PIM shield of the passive antenna can be provided by a U-shaped structure and the rear wall of the passive antenna can be inside the U-shaped structure with an open end of the U facing the front radome of the passive antenna.

The PIM shield can have a first longitudinally extending body coupled to a second longitudinally extending body. The first and second longitudinally extending bodies can cooperate to define a plurality of longitudinally extending windows, at least one of the windows configured to receive a mounting bracket of the passive antenna.

The PIM shield can have a rear wall with first and second laterally spaced apart and rearwardly extending projections that extend longitudinally along at least a portion of a length of the passive antenna thereby providing a maximum wind load reduction relative to antenna systems without the PIM shield.

Embodiments of the present invention include a passive antenna system with: a base station antenna housing having a front radome and a rear wall spaced apart from the front radome and extending between right and left sidewalls that are longitudinally extending sidewalls; a passive antenna assembly in the base station housing with a plurality of columns of first radiating elements configured for operating in a first operational frequency band; and a passive intermodulation (PIM) shield configured to enclose at least part of the base station antenna housing and including a frequency selective surface that extends across at least part of the PIM shield behind the base station antenna housing, wherein the FSS is configured to reflect, absorb or block electromagnetic waves within the first operational frequency band.

The right and left sidewalls can include a metallized radome surface or reside adjacent longitudinally extending sidewalls of the PIM shield and are configured to reflect signal from the first operational frequency band from the plurality of first radiating elements back into the base station antenna housing.

Embodiments of the present invention are directed to a passive intermodulation (PIM) shield for an antenna system. The PIM shield has a PIM shield body having a rear wall extending between left and right sidewalls. The PIM shield body defines a cavity between the left and right sidewalls and in front of the rear wall. The cavity is sized and configured to receive at least part of a housing of an antenna of the antenna system and the PIM shield body includes a frequency selective surface that extends across at least part of the rear wall for at least part of a length of the PIM shield body.

The PIM shield body can have a first longitudinally extending body coupled to a second longitudinally extending body, and wherein the first and second longitudinally extending bodies can define a plurality of longitudinally extending windows with at least one of the windows configured to receive a mounting bracket of the antenna system.

The rear wall can have first and second laterally spaced apart and rearwardly extending projections that extend longitudinally along at least a portion of a length of the PIM shield thereby reducing a maximum wind load

Embodiments of the present invention provide a method of providing passive intermodulation (PIM) shielding. The method includes providing a PIM shield comprising a frequency selective surface; and coupling the PIM shield to a housing of a base station antenna comprising radiating elements therein.

The housing can be passive antenna housing, and the PIM shield can have an external three-dimensional structure that is sized and configured to receive at least a rear wall and at least part of sidewalls of the passive antenna housing therein.

The PIM shield can have first and second cooperating bodies that extend laterally and longitudinally. The coupling can be carried out by: aligning the first and second cooperating bodies behind a rear wall of the housing so that window portions are longitudinally aligned; then attaching the first and second cooperating bodies together to form a rear wall whereby a first window receives a first mounting bracket of the housing and a second window receives a second mounting bracket of the housing; engaging a bracket attachment of each of the first and second cooperating bodies to the first mounting bracket; and affixing the bracket attachments to the first mounting bracket to thereby couple the PIM shield to the housing.

### BRIEF DESCRIPTION OF THE DRAWINGS

FIG. 1 is a simplified schematic view of a prior art base station antenna.

FIG. 2 is a rear, perspective view of a base station antenna with PIM shield comprising a frequency selective surface applied to the active antenna according to embodiments of the present invention.

FIG. 3 is a simplified cross-sectional view of an example active antenna with an example PIM shield structure enclosing at least part of the active antenna according to embodiments of the present invention.

FIG. 4 is a rear, side perspective view of another example of a PIM shield structure for a base station antenna according to embodiments of the present invention.

FIG. 5A is a rear, side perspective view of another example of a PIM shield structure for a base station antenna according to embodiments of the present invention.

FIG. 5B is a side, perspective view of a PIM shield structure according to embodiments of the present invention.

FIG. 5C is a side, top perspective view of a PIM shield structure provided by a concealment shroud that can surround the active antenna according to embodiments of the present invention.

FIGS. 6A-6C are rear, side perspective views of other embodiments of example PIM shield structures for an active antenna of a base station antenna according to embodiments of the present invention.

FIGS. 7 and 8 are simplified cross-sectional view of example active antenna with a frequency selective surface provided by a radome according to embodiments of the present invention.

FIG. 9 is a simplified schematic illustration of an example flex panel providing a metal grid pattern forming a frequency selective surface for PIM shield according to embodiments of the present invention.

FIG. 10 is a simplified schematic view of an example tape comprising a frequency selective surface that can be used to provide PIM shield for an active antenna and/or passive base station antenna according to embodiments of the present invention.

FIGS. 11 and 12 are simplified cross-sectional views of a passive antenna with example PIM shield configurations according to embodiments of the present invention.

FIG. 13 is a rear, side perspective view of a passive antenna comprising PIM shield provided by a frequency selective surface applied to one or more surfaces of the housing such as the rear radome and/or sidewalls of the housing according to embodiments of the present invention.

FIG. 14 is a rear, side perspective view of a PIM shield structure that can be used to partially enclose the passive antenna, leaving the front radome thereof exposed, according to embodiments of the present invention.

FIG. 15 is a side, partially exploded view of a passive antenna assembly and an active antenna, each comprising frequency selective surfaces for PIM shield according to embodiments of the present invention.

FIG. 16A is a front perspective view of an example passive antenna assembly (shown without the radome) according to embodiments of the present invention.

FIG. 16B is a side view of the example passive antenna assembly shown in FIG. 16A.

FIG. 17 is a front view of an example pattern unit cell array/grid of an FSS according to embodiments of the present invention.

FIGS. 18A and 18B are simplified schematics of a passive base station antenna with a PIM shield comprising FSS shield features and a spaced apart active antenna with PIM shield features comprising FSS shield features according to embodiments of the present invention.

FIG. 19 is a flow chart of example actions for aftermarket use for retrofitting/addressing PIM issues for base station antennas according to embodiments of the present invention.

FIG. 20 is an end view of a PIM shield structure that can be used to partially enclose a target structure such as a passive or active antenna, leaving the front radome thereof exposed, according to embodiments of the present invention.

FIG. 21 is a greatly enlarged view of a portion of the PIM shield structure shown in FIG. 20 according to embodiments of the present invention.

FIG. 22 is an end view of a passive antenna with the PIM shield structure of FIG. 20 coupled thereto.

FIG. 23 is a schematic image of wind load of the passive antenna with the PIM shield as calculated by a computational model.

FIG. 24 is a rear view of example PIM shield structures of different sizes according to embodiments of the present invention.

FIG. 25A is a front view of an example PIM shield structure (the view facing the front of the radome, when assembled) according to embodiments of the present invention.

FIG. 25B is a rear view of the example PIM shield structure shown in FIG. 25A according to embodiments of the present invention.

FIGS. 26A-26D are rear, side perspective views of an example installation sequence according to embodiments of the present invention.

FIGS. 27A-27D show enlarged features of attachment components shown in FIGS. 26A-26D according to embodiments of the present invention.

FIG. 28A is a front view of a base station antenna (a passive antenna) in front of a target mounting structure, shown as a pole.

FIGS. 28B and 28C are rear views of embodiments of the base station antenna shown in FIG. 28A.

FIG. 28D is a front view of the base station antenna shown in FIG. 28A coupled to a PIM shield structure according to embodiments of the present invention.

FIGS. 28E and 28F are rear views of different embodiments of the assembly shown in FIG. 28D according to embodiments of the present invention.

FIG. 29 is an enlarged view of a window cover shown in FIG. 28F.

FIG. 30 is a rear perspective view of an assembly with the base station antenna housing (passive antenna) with the rear wall thereof enclosed in a PIM shield structure according to embodiments of the present invention.

FIG. 31 is a rear view of the assembly shown in FIG. 30.

FIG. 32 is a rear, end perspective view of another example PIM shield structure provided about a rear and side walls of a base station antenna housing according to embodiments of the present invention.

FIG. 33 is a rear, side perspective end view of another example PIM shield structure provided about a rear and side walls of a base station antenna housing according to embodiments of the present invention.

### DETAILED DESCRIPTION

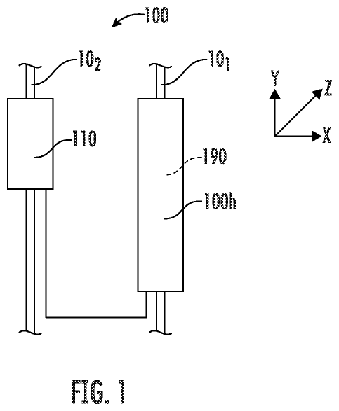

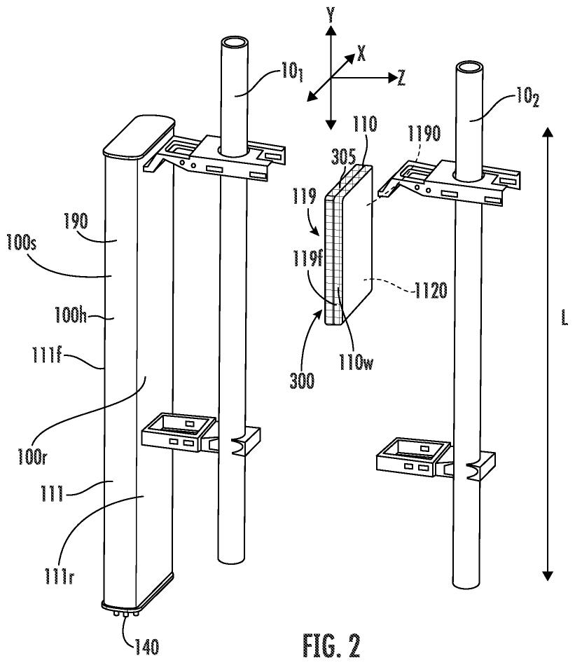

Embodiments of the present invention are directed to base station antennas. In the description that follows, these base station antennas will be described using terms that assume that the antenna is mounted for use on a tower, pole, roof, wall or other mounting structure 10₁, 10₂ (FIGS. 1, 2) with the longitudinal axis L (FIG. 2) of the passive base station antenna extending along a vertical (Y) axis and the front of the base station antenna mounted opposite the tower, pole or other mounting structure pointing toward the target coverage area for the base station antenna. It will be appreciated that the base station antennas may not always be mounted so that the longitudinal axes thereof extend along a vertical axis. For example, the base station antennas may be tilted slightly (e.g., less than 10°) with respect to the vertical axis so that the resultant antenna beams formed by the base station antennas each have a small mechanical downtilt.

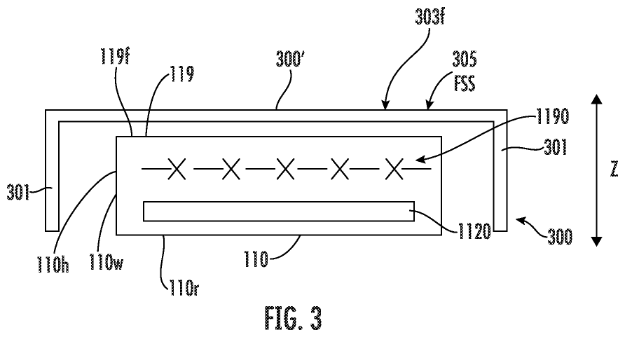

FIG. 1 illustrates an example (passive) base station antenna 100. The base station antenna 100 can reside adjacent to, couple to or include at least one active antenna 110. The term “active antenna” is used interchangeably with “active antenna unit” and “AAU” and refers to a cellular communications unit comprising radio circuitry and associated radiating elements. The radio circuitry is capable of electronically adjusting the amplitude and/or phase of the subcomponents of an RF signal that are output to different radiating elements of an array of radiating elements or groups thereof. The active antenna 110 may include both the radio circuitry and a radiating element array 1190 (FIGS. 2, 3) (e.g., a multi-input-multi-output (mMIMO) beamforming antenna array) and may include other components such as filters, a calibration network, an antenna interface signal group (AISG) controller and the like. The active antenna 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a Z (front to back) direction, with the radiating element array 1190 closer to the radome 119 than the radio circuitry 1120. The active antenna 110 may operate as a stand-alone unit that is mounted on an antenna tower or may be included as part of the (passive antenna) base station antenna 100.

As will be discussed further below, the (passive) base station antenna 100 includes an antenna assembly 190 (FIGS. 2, 16A, 16B) inside a base station antenna housing 100h, which can be referred to as a “passive antenna assembly”. The term “passive antenna assembly” refers to an antenna assembly having one or more arrays of radiating elements that are coupled to radios that are external to the passive antenna assembly, typically remote radio heads that are mounted in close proximity to the base station antenna housing 100h. The arrays of radiating elements included in the passive antenna assembly 190 (FIGS. 16A, 16B) are configured to form static antenna beams (e.g., antenna beams that are each configured to cover a sector of a base station). The passive antenna assembly 190 may comprise a reflector 170, with radiating elements projecting in front of the reflector and the radiating elements can include one or more linear arrays of low band radiating elements that operate in all or part of the 617-960 MHz frequency band and/or one or more linear arrays of mid-band radiating elements that operate in all or part of the 1427-2690 MHz frequency band. The passive antenna assembly 190 (FIGS. 16A, 16B) is mounted in the housing 100h of base station antenna 100.

The (passive) base station antenna housing 100h may be substantially rectangular with a flat rectangular cross-section. At least a front side of the housing 100h may be implemented as include a radome 111. A radome refers to a dielectric cover that allows RF energy to pass through in certain frequency bands. A rear 100r of the housing 100h may also include a rear 111r radome that is opposite the front side radome 111f. Optionally, the housing 100h and the radome 111 can also comprise two (narrow) sidewalls 100s, facing each other and extending rearwardly between the front radome 111f and the rear radome 111r. The sidewalls 100s can comprise the radome material and can have a width, measured in a front-to-back direction, that is 40%-90% less than a lateral extent of the housing 100h. The radome 111 may be formed of, for example, fiberglass or plastic. The rear radome 111r may be formed of a different material than the front radome 111f.

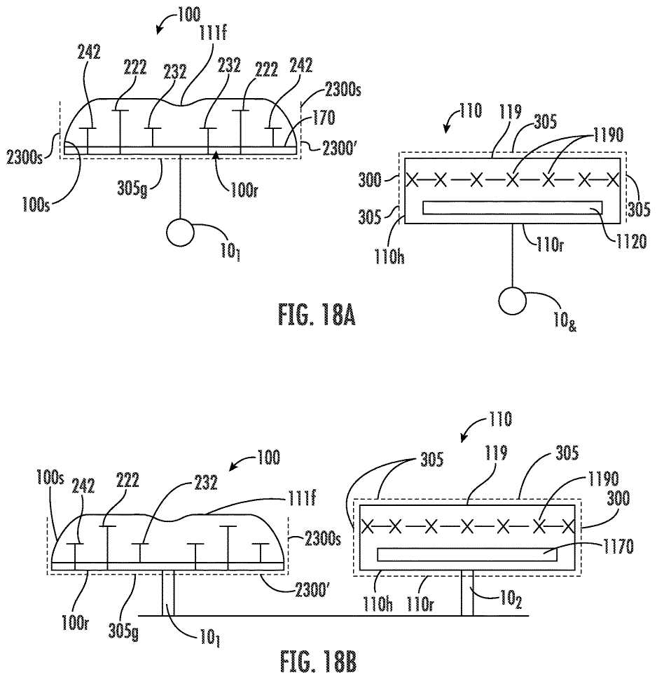

Referring to FIGS. 1 and 2, the passive antenna assembly 190 in the base station antenna housing 100h can be mounted to a first mounting structure 10₁ such as a pole or other mounting structure, such as a building, and the active antenna 110 can be mounted to a second mounting structure 10₂ such as a pole or other mounting structure, such as a building. The two mounting structures 10₁, 10₂ can be laterally spaced apart a distance in a “X” direction, in some embodiments. In some cases, the active antenna 110 may be mounted forwardly of the passive antenna assembly 190 (FIG. 18B) or about “even” with the passive antenna assembly 190 and may be on the same mounting structure. In some cases, the passive base station antenna 100 and the active antenna 110 can be mounted with some level of rotation on a single mounting structure, such as a pole, to point to center of sector regardless of direction of the mounting face. In such situations, RF energy emitted by the arrays of radiating elements in the passive antenna assembly 190 may impinge on the active antenna and may form currents on metal structures on the exterior of the active antenna 110. If these currents flow through inconsistent metal-to-metal connections or other PIM generating elements on the active antenna 110, then intermodulation products may arise. These intermodulation products may radiate in various directions and portions of these PIM signals may be received within the passive antenna assembly where they may appear as PIM distortion. This PIM distortion may, in some cases, severely degrade the performance of the passive antenna assembly 190.

Active antennas such as active antenna 110 are often configured to operate using time division duplexing multiple access schemes in which the transmit and receive signals do not overlap in time, but instead the active antenna transmits RF signals during selected time slots and receives RF signals during other time slots. As a result, the amount of PIM that can be tolerated by an active antenna 110 may be much higher than the PIM levels that are acceptable for passive antenna assemblies that operate under frequency division duplexing (FDD) multiple access schemes. In such FDD systems, the PIM signal(s) can be as large as signals being received by the low band and/or mid band radiating elements.

Referring to FIG. 2, a PIM shield 300 can be positioned on, about or in the active antenna 110. In this example embodiment, the PIM shield 300 can be applied directly to the radome 119/exterior housing 110h of the active antenna 110. The PIM shield 300 comprises a frequency selective surface (FSS) 305. The FSS 305 of the PIM shield 300 can be provided in a number of ways. The FSS 305 may be configured to pass RF signals within the operating frequency band of the active antenna 110 and to reflect and/or absorb RF signals within the operating frequency bands of nearby passive antenna assemblies 190. For example, the FSS 305 may be configured to pass RF signals in some or all of a high-band frequency range (e.g., the 3.1-5.8 GHz frequency range) while reflecting and/pr absorbing RF signals in the above-described low-band and mid-band frequency ranges. In the example shown, the FSS 305 can be patterned onto the radome 119 or adhesively attached to the radome/exterior housing 119.

For example, a flexible film or flexible printed circuit board with a pattern of unit cells/grid can be adhesively attached to one or more surfaces of the active antenna 110. In other examples, a metallized pattern can be printed onto a surface of the radome 119. The metallized pattern may be inside or outside the radome 119 or on both the inside or outside of the radome 119.

The PIM shield 300 can extend across and along an external or internal front surface 119f of the radome 119. As shown, the PIM shield 300 can also extend rearwardly at least partially about sidewalls 110w of the active antenna 110. The part of the PIM shield 300 that extends about the sidewalls 110w can be solid metal or be defined by the FSS 305.

Turning now to FIG. 3, the PIM shield 300′ can be provided as an external PIM shield 300′ that is separate from and external to the active antenna 110. The PIM shield 300′ can have a box structure with rearwardly and longitudinally extending right and left side walls 301 with a front 303f extending therebetween. The PIM shield structure 300′ can abut the active antenna 110 or be closely spaced apart therefrom, typically within 1-10 mm, and enclose the front radome 119 and at least part of the sidewalls 110w of the active antenna 110 with the FSS 305 extending across and along at least a major portion of the front radome 119.

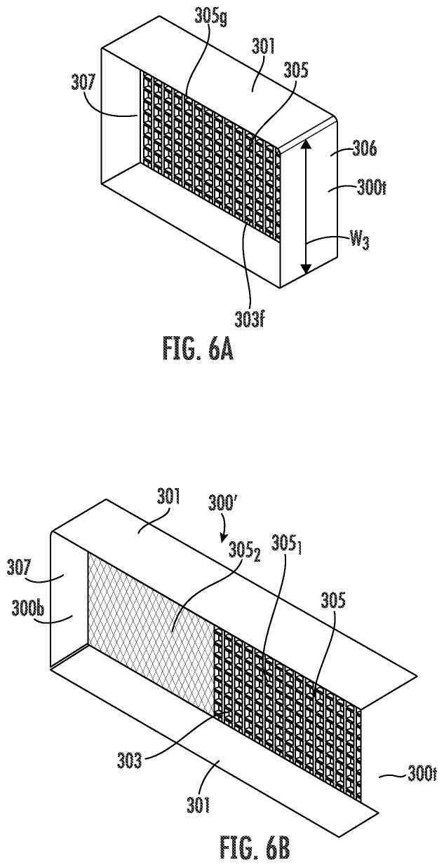

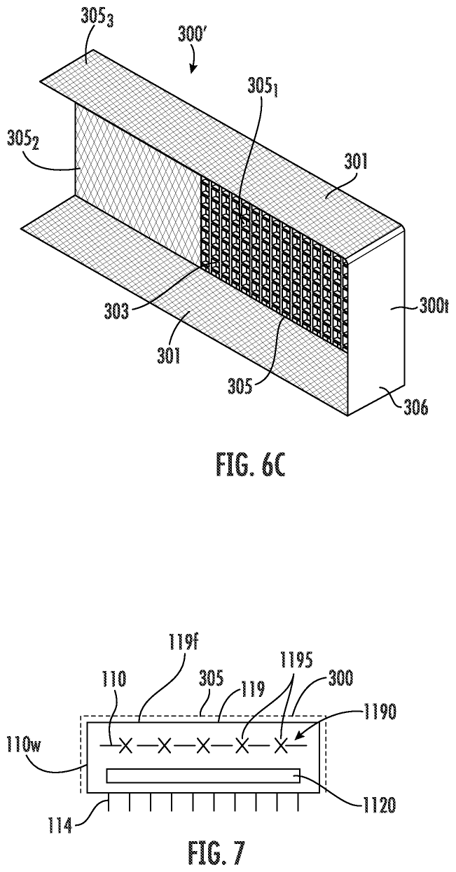

At least the front 303f can comprise the frequency selective surface (FSS) 305. The FSS 305 can be provided with a pattern of unit cells forming a grid pattern 305g (FIG. 6A).

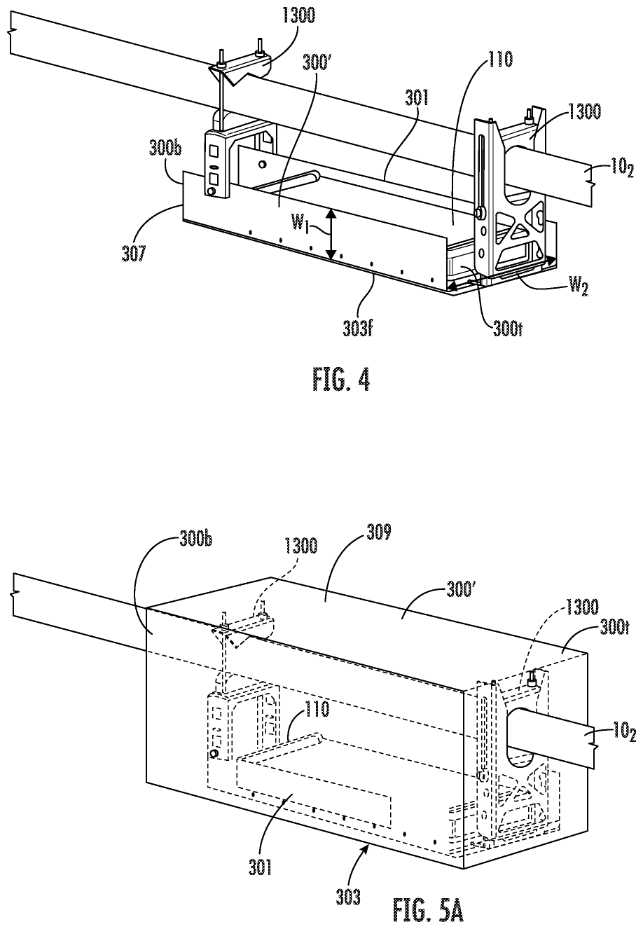

FIG. 4 shows an example of the PIM shield 300′ in position about the active antenna 110 and with the active antenna mounted to the pole 10₂. The sidewalls 301 of the PIM shield 300′ can extend rearward (front to back direction) a distance from a front primary surface of the active antenna 110 and, in some cases may extend rearwardly pass a primary rear surface 110r (FIG. 18) of the active antenna 110. The top 300t of the PIM shield 300′ can be open (FIGS. 4, 6B) or closed (FIGS. 6A, 6C, top wall 306). The bottom 300b of the PIM shield 300′ can be open (FIG. 6C) or closed (FIGS. 4, 6B, bottom wall 307). Thus, in these examples, there are three to five walls (a front wall, two sides and one, both or neither of the top and bottom sides/walls) providing a box configuration.

The PIM shield 300′ can extend between two brackets 1300. The sidewalls 301 can have an extent, in a front to back direction, W₁ that is less than a width W₂ of the active antenna and width W₃ of the PIM shield 300′. The brackets 1300 can be attached to the PIM shield 300′ and the active antenna 110. Alternatively, the brackets 1300 can hold the PIM shield 300′ and the PIM shield 300′ can be attached to the active antenna 110. Other attachment arrangements are contemplated.

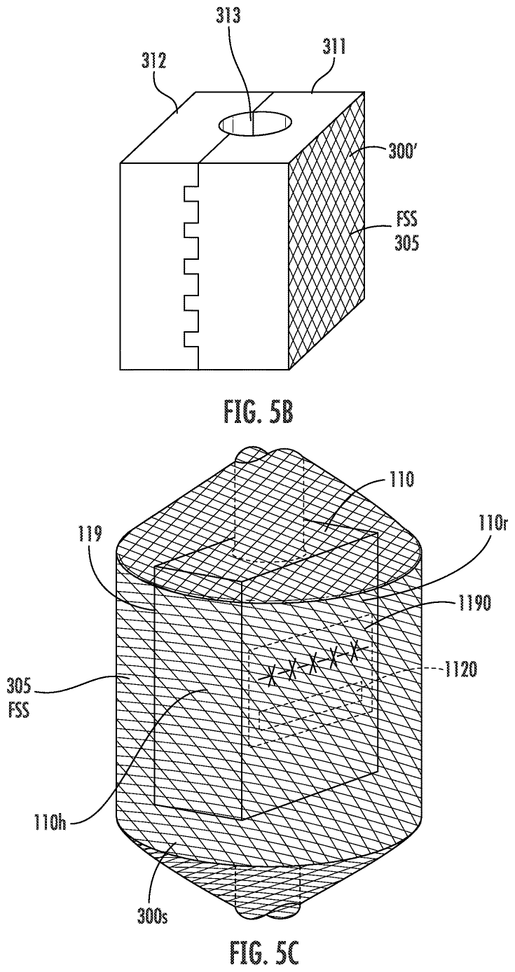

Turning to FIG. 5A, in this example, the PIM shield 300′ is configured to extend rearwardly a distance sufficient to enclose the pole 10₂ and the active antenna 110. The brackets 1300 may optionally also be enclosed in the PIM shield 300′. The PIM shield 300′ can be attached the brackets 1300 and/or to the pole 10₂ for positional support. Optionally, the PIM shield 300′ can also have a rear wall 309 that is attached to the side walls and faces the FSS 305 of the front 303f and can optionally enclose a chamber in the PIM shield 300′.

FIG. 5B shows the PIM shield 300′ can have cooperating members 311, 312 that slidably close and lock together and surround the pole 10₂ with the pole in the longitudinally extending pole channel 313. Other configurations of the PIM shield 300′ are contemplated including omitting the rear wall 309, hinging certain of the walls for ease of installation and attaching different segments of the PIM shield 300′ via snap or frictional fit to each other or a respective bracket 1300.

FIG. 5C shows that the PIM shield 300′ can surround the active antenna 110, either abutting or spaced apart from the housing 110h and radome thereof 119, to provide a concealment shroud 300s comprising a FSS 305. The geometry of the concealment shroud 300s can be cylindrical or oval as shown or may be rectangular and surround the active antenna 110 but not the pole or mounting bracket therefor. The concealment shroud 300s can have a closed or open top and a closed or open bottom. If closed, the top and/or bottom can also comprise a FSS 305.

FIGS. 6A-6C illustrate example embodiments of the PIM shield 300′ for the active antenna 110. FIGS. 6B and 6C illustrate that the FSS 305 can be provided as first and second FSS regions 305₁, 305₂, each with pattern unit configurations that vary and may be configured to block or reflect at different frequency bands. FIG. 6C shows the sidewalls 301 have a second FSS configuration different from the first FSS configuration 305₁ provided at the front 303f of the PIM shield 300′.

The FSS 305 can be configured to allow high band radiating elements 1190 located in the active antenna 110) to propagate electromagnetic waves therethrough and to reflect, block or absorb lower band RF signals (lower band electromagnetic waves).

The FSS 305 can be provided, for example, by a printed circuit board or a flexible printed circuit board defining a metal grid pattern of unit cell structures, metallized film or tape having an FSS pattern thereon, a sheet of metal provided with a grid pattern or a radome with a metal grid pattern printed thereon to provide a metallized grid or a non-metallic substrate comprising a metallized surface in a grid pattern.

The FSS 305 can be configured to allow RF energy (electromagnetic waves) to pass through at one or more first defined frequency range and that is configured to reflect and/or absorb RF energy at a different second frequency band. Thus, the FSS 305 of the PIM shielding structure 300 can reside behind at least some antenna elements of the passive antenna assembly 190 and can selectively reject some frequency bands and permit other frequency bands such as those of the antenna elements 1190 of the active antenna 110 to pass therethrough by including the frequency selective surface and/or substrate to operate as a type of “spatial filter”.

A discussion of some example FSSs can be found in Ben A. Munk, Frequency Selective Surfaces: Theory and Design, ISBN: 978-0-471-37047-5; DOI: 10.1002/0471723770; April 2000, Copyright© 2000 John Wiley & Sons, Inc., the contents of which are hereby incorporated by reference as if recited in full herein. See also, co-pending U.S. patent application Ser. No. 17/468,783, the contents of which are also incorporated by reference as if recited in full herein.

The FSS 305 can comprise, in some embodiments, metamaterial, a suitable RF material or even air (although air may require a more complex assembly). The term “metamaterial” refers to composite electromagnetic (EM) materials. Metamaterials may comprise sub-wavelength periodic microstructures. The FSS 305 may be configured to reduce or prevent low-band and mid-band RF energy emitted by the passive antenna assembly 190 from impinging on the active antenna 110, since the FSS 305 is positioned between the passive antenna assembly 190 and the active antenna 110 and acts to reflect and/or absorb the low-band and mid-band RF energy emitted by the passive antenna assembly 190. Since much or all of the low-band and mid-band RF energy emitted by the passive antenna assembly 190 will not impinge on the active antenna 110, the generation of PIM distortion by surfaces on the active antenna 110 may be reduced or prevented. Moreover, the FSS 305 may be designed to be a relatively PIM-free structure that will not generate intermodulation products in response to low-band and mid-band RF energy emitted by the passive antenna assembly 190. Thus, the FSS 305 may significantly reduce the amount of PIM distortion generated in response to low-band and mid-band RF energy emitted by the passive antenna assembly 190.

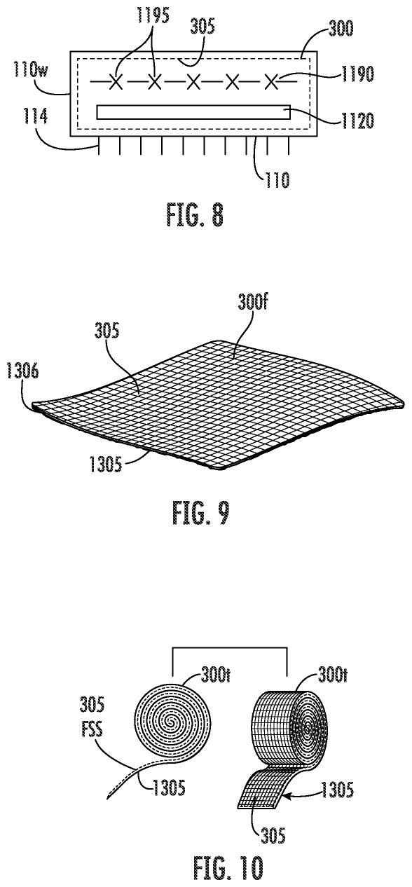

Referring to FIGS. 7 and 8, the FSS 305 can be applied directly to the radome 119 and the laterally and longitudinally extending sidewalls 110w. FIG. 7 shows the FSS 305 on external surfaces of the active antenna 110 and FIG. 8 shows the FSS 305 on internal surfaces thereof. FIG. 7 shows the FSS 305 terminating adjacent a rear of the active antenna 110, optionally adjacent heat fins 114. FIG. 8 shows the FSS 305 continuing on a rear wall of the active antenna 110.

FIG. 9 shows that the PIM shield 300 providing the FSS 305 can be a film 300f with an adhesive 1305. The film 300f can be provided in sheets or as a rolled or rollable sheet stock of material that can be dispensed to size onsite or may be delivered in selected or standard panel sizes. A releasable cover layer 1306 can be attached to the adhesive side of the film 300f. The film 300f with the FSS 305 can be used to provide a flexible blanket that extends about target components to provide the FSS 305 without requiring a preformed PIM shield structure. For example, instead of the box PIM shield 300′ shown in FIG. 5A, the film 300f can be wrapped about the pole and active antenna 110 or the active antenna 110 alone to provide a blanket sheath enclosure with the FSS 305.

It is contemplated that different rolls or packages of tapes 300t and/or films 300f can be provided with different configurations of FSS 305, different unit cell patterns, configured to block or reflect and pass at different frequency bands. These tapes, films, 300t, 300f can be color coded for ease of installation to a correct component.

FIG. 10 shows that the PIM shield 300 can be provided by a tape 300t comprising the FSS 305 and adhesive 1305.

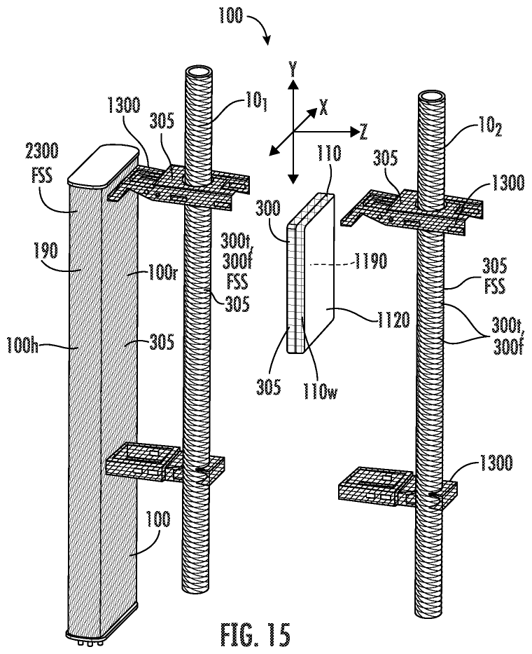

The tape 300t or film 300f can be used with other PIM shields 300, 300′, 2300, 2300′ such as those discussed herein (see, FIG. 15).

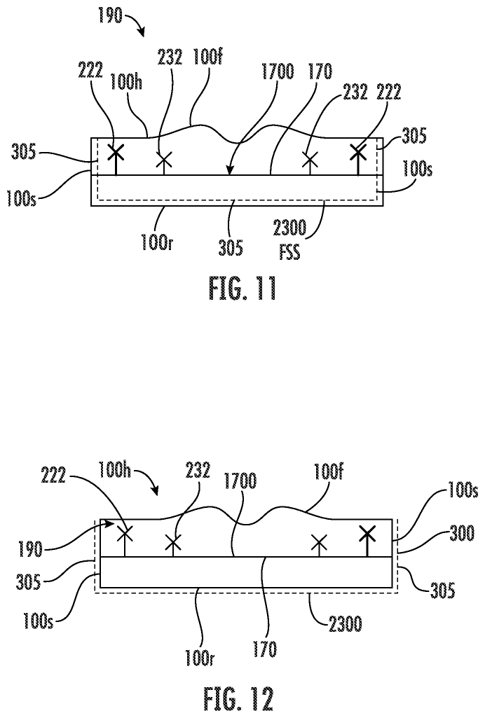

FIGS. 11 and 12 show the passive antenna/base station antenna housing 100h can also comprise a PIM shield 2300.

Referring to FIGS. 11 and 12, the FSS 305 of the PIM shield 2300 can be applied directly to the rear wall 100r/rear radome 111r and the longitudinally extending sidewalls 100s as discussed above with respect to the radome 119 of the active antenna 110 (e.g., printed or otherwise patterned onto or adhesively attached thereto). FIG. 11 shows the FSS 305 on internal rear 100r and sidewall 100s surfaces of the housing 100h behind the front radome 111f and FIG. 12 shows the FSS 305 on or adjacent external rear and sidewall surfaces 100r, 100s. The FSS 305 can be held in the housing 100h without being indirectly or directly attached or formed onto the radome 111.

Thus, the base station antenna housing 100h can comprise a PIM FSS 305 that extends across a lateral extent of a rear 100r of the base station housing 100h, behind a low band reflector 170 that can be provided as a FSS reflector 1700 that is in front of the PIM shield 2300 comprising the PIM FSS 305. The base station antenna housing 100h can include a PIM FSS 305 that extends along right and left sidewalls 100s of the base station antenna housing 100h and that is configured to block radiation from low band and mid band radiating elements 222, 232 (FIGS. 16A, 16B) therein from propagating out of the base station antenna housing 100h in rearward and sideward directions toward the active antenna 110. When a PIM FSS 305 is applied to the passive antenna assembly 190, it may, for example, be designed to pass RF energy in the low-band and mid-band frequency ranges and to reflect/absorb RF energy in the high-band frequency range. This may help reduce PIM distortion that could be caused by high-band RF energy emitted by the active antenna 110 from entering the passive antenna assembly 190 and generating PIM within the passive antenna assembly 190.

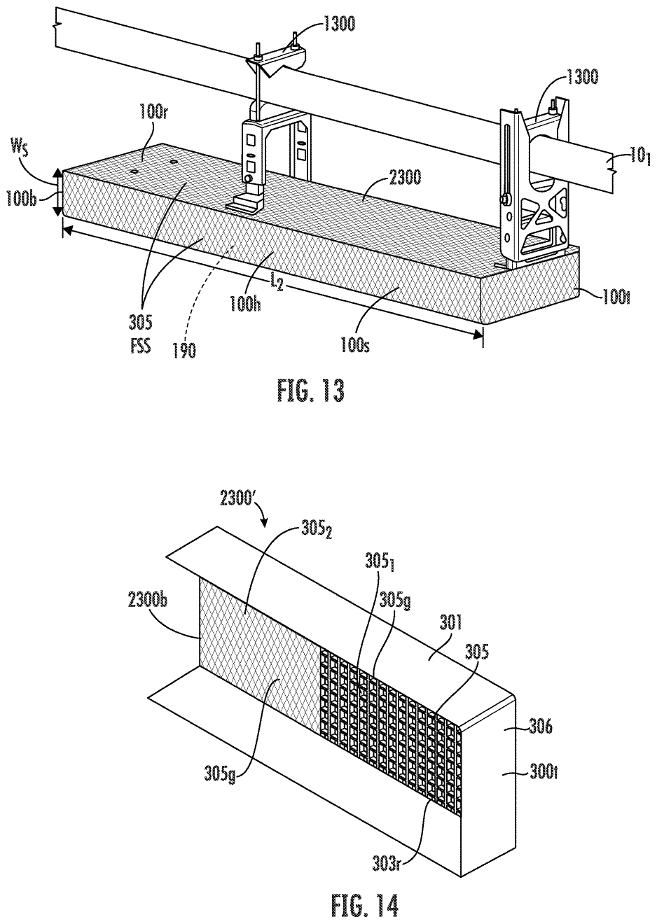

Turning to FIG. 13, the base station antenna housing 100h with the passive antenna assembly 190 can comprise a PIM shield 2300 that includes an FSS 305 configured to extend across and at least a sub-length along one or more surfaces such as the rear wall 100r and, in a front to back direction, at least part of the sidewalls 100s.

FIG. 14 shows the PIM shield 2300′ can be provided as a PIM shield 2300′ with a box structure with walls 301 and at least one surface 303r with an FSS 305 similar to the PIM shield 300′ for the active antenna 110. The PIM shield 2300′ can include first and second FSS segments 305₁, 305₂ with different FSS unit cell patterns/grid patterns. The PIM shield 2300′ can be configured to enclose the rear 100r and at least part of the sidewalls 100s of the housing 100h along at least 30 percent of a length of the housing 100h. The PIM shield 2300′ can have an open bottom 2300b and a closed top 2300t with top wall 306. However, a bottom wall 307 (FIG. 6A) may be provided and a top wall may be omitted or PIM shield 2300′ can be devoid of both the bottom and top walls, visually exposing the top and bottom 100t, 100b, of the base station antenna 100. The sidewalls 301 can project forward a sufficient distance to cover at least part of the width Ws (front to back direction dimension) of the sidewalls 100s.

The sidewalls 301 may have a length that is greater than a length of the rear facing wall surface 303r with an FSS 305. The rear facing wall surface 303r faces the rear 100r of the housing 100h of the base station antenna 100 with the passive antenna assembly 190.

The PIM shield 2300, 2300′ can be configured to provide a metal surface or metal patterned surface to the radome 111 of at least a sub-length of the sidewalls 100s to provide a PIM shield segment of the PIM shield 2300.

The FSS 305 can comprise shaped metal patches of any suitable geometry.

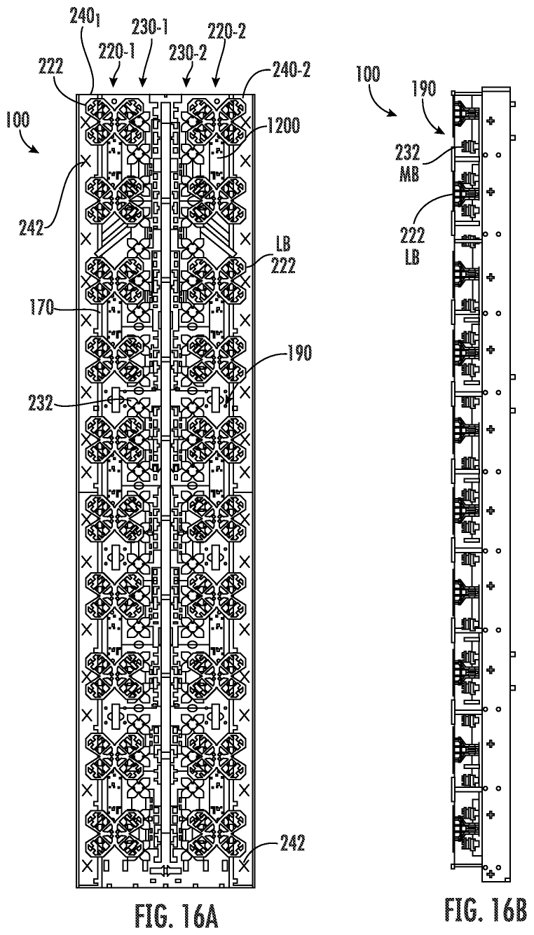

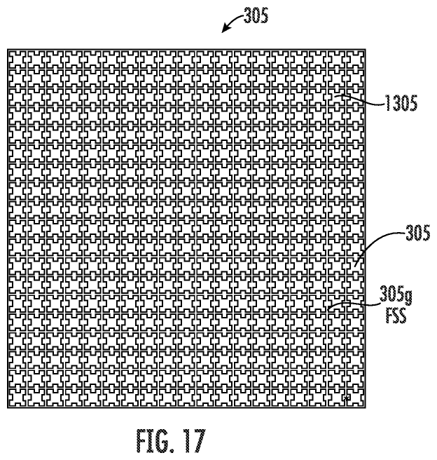

In some embodiments, at least part of the FSS 305 of the PIM shield 300′ of the active antenna 110 and/or the PIM shield 2300′ of the base station antenna housing 100h can be provided by a sheet or sheets of metal that is/are stamped, punched, acid etched, or otherwise formed to provide a grid pattern 305g. The grid pattern 305g can be configured to have closed or open unit cells 1305 (FIG. 17) of any suitable geometry.

The PIM shield 2300′ can provide the front 303f and side walls 301 as a unitary monolithic shaped body of sheet metal. The PIM shield 2300′ can be configured to provide the rear facing wall 303r and sidewalls 301 as a unitary monolithic shaped body of sheet metal.

Turning now to FIG. 15, an example configuration of a base station antenna 100 with active antenna 110 and base station antenna housing 100h, each having a respective PIM shield 300, 300′ and 2300, 2300′ comprising FSS 305 is shown. Also, the mounting structure 10₁, 10₂ and brackets 1300 can comprise PIM shields 300′, 300t, 300f of FSS 305 that may suppress PIM issues/RF noise at installation cites.

Turning now to FIGS. 16A, 16B, an example passive antenna assembly 190 is shown. The antenna assembly 190 comprises multiple arrays of radiating elements, typically provided in columns, with radiating elements that extend forwardly from the reflector 170. The arrays of radiating elements of the antenna assembly 190 may comprise radiating elements 222 that are configured to operate in a first frequency band and radiating elements 232 that are configured to operate in a second frequency band. Other arrays of radiating elements may comprise radiating elements that are configured to operate in either the second frequency band or in a third frequency band. The first, second and third frequency bands may be different frequency bands (although potentially overlapping).

Some of the radiating elements of the passive antenna assembly may be mounted to extend forwardly from the reflector 170, and, if dipole-based radiating elements are used, the dipole radiators of these radiating elements may be mounted approximately ¼ of a wavelength of the operating frequency for each radiating element forwardly of the reflector 170. The reflector 170 may serve as a reflector and as a ground plane for the radiating elements of the base station antenna 100 that are mounted thereon.

Still referring to FIGS. 16A, 16B, the passive antenna assembly 190 of the base station antenna 100 can include one or more arrays 220 of low-band radiating elements 222, one or more arrays 230 of first mid-band radiating elements 232, one or more arrays of second mid-band radiating elements 242. The radiating elements 222, 232, 242 may each be dual-polarized radiating elements. Further details of radiating elements can be found in co-pending WO2019/236203 and WO2020/072880, the contents of which are hereby incorporated by reference as if recited in full herein. Further details of an example passive base station antenna can be found in U.S. Pat. No. 10,770,803, the contents of which are hereby incorporated by reference as if recited in full herein.

It will also be appreciated that the number of arrays of low-band and mid-band radiating elements may be varied from what is shown in the figures. For example, the number of arrays of each type of radiating elements may be varied from what is shown, some types of arrays may be omitted and/or other types of arrays may be added, the number of radiating elements per array may be varied from what is shown, and/or the arrays may be arranged differently.

Each array 220-1, 220-2 of low-band radiating elements 222 may be used to form a pair of antenna beams, namely an antenna beam for each of the two polarizations at which the dual-polarized radiating elements are designed to transmit and receive RF signals. Likewise, each array 230-1, 230-2 of first mid-band radiating elements 232, and each array 242 of second mid-band radiating elements 242 may be configured to form a pair of antenna beams, namely an antenna beam for each of the two polarizations at which the dual-polarized radiating elements are designed to transmit and receive RF signals. Each linear array 220, 230, 240 may be configured to provide service to a sector of a base station. For example, each linear array 220, 230, 240 may be configured to provide coverage to approximately 120° in the azimuth plane so that the base station antenna 100 may act as a sector antenna for a three-sector base station. Of course, it will be appreciated that the linear arrays may be configured to provide coverage over different azimuth beamwidths. While all of the radiating elements 222, 232, 242 can be dual-polarized radiating elements in the depicted embodiments, it will be appreciated that in other embodiments some or all of the dual-polarized radiating elements may be replaced with single-polarized radiating elements. It will also be appreciated that while the radiating elements are illustrated as dipole radiating elements in the depicted embodiment, other types of radiating elements such as, for example, patch radiating elements may be used in other embodiments.

Some or all of the radiating elements 222, 232, 242 may be mounted on feed boards that couple RF signals to and from the individual radiating elements 222, 232, 242, with one or more radiating elements 222, 232, 242 mounted on each feed board. Cables (not shown) and/or connectors may be used to connect each feed board to other components of the antenna 100 such as diplexers, phase shifters, calibration boards or the like.

RF connectors or “ports” 140 (FIG. 2) can be mounted in the bottom end cap that are used to couple RF signals from external remote radio units to the arrays 220, 230, 240 of the passive antenna assembly 190. Two RF ports can be provided for each array 220, 230, 240 namely a first RF port 140 that couples first polarization RF signals between the remote radio unit and the array 220, 230, 240 and a second RF port 140 that couples second polarization RF signals between the remote radio unit and the array 220, 230, 240. As the radiating elements 222, 232, 242 can be slant cross-dipole radiating elements, the first and second polarizations may be a −45° polarization and a +45° polarization.

A phase shifter may be connected to a respective one of the RF ports 140. The phase shifters may be implemented as, for example, wiper arc phase shifters such as the phase shifters disclosed in U.S. Pat. No. 7,907,096 to Timofeev, the disclosure of which is hereby incorporated herein in its entirety. A mechanical linkage may be coupled to a RET actuator (not shown). The RET actuator may apply a force to the mechanical linkage which in turn adjusts a moveable element on the phase shifter in order to electronically adjust the downtilt angles of antenna beams that are generated by the one or more of the low-band or mid-band linear arrays 220, 230, 240.

It should be noted that a multi-connector RF port (also referred to as a “cluster” connector) can be used as opposed to individual RF ports 140 (FIG. 2). Suitable cluster connectors are disclosed in U.S. patent application Ser. No. 16/375,530, filed Apr. 4, 2019, the entire content of which is incorporated herein by reference.

The radiating elements 222 can be dipole elements configured to operate in some or all the 617-960 MHz frequency band. Further discussions of example antenna elements including antenna elements comprising feed stalks can be found in U.S. Provisional Patent Application Ser. Nos. 63/087,451 and 62/993,925 and/or related utility patent applications claiming priority thereto, the contents of which are hereby incorporated by reference as if recited in full herein.

Some or all of the low or mid-band radiating elements 222, 232, respectively, may be mounted on the feed boards 1200 and can couple RF signals to and from the individual radiating elements 222, 232. Cables (not shown) and/or connectors may be used to connect each feed board to other components of the base station antenna 100 such as diplexers, phase shifters, calibration boards or the like.

Referring to FIG. 17, a grid pattern 305g can be provided by a sheet(s) of metal, metal patches or metallized pattern on a non-metallic substrate and/or a printed circuit board, and can be configured to provide with an array of unit cells 1305 having shaped metal patches that are configured to allow high band radiating elements to propagate electromagnetic waves and reflect/absorb low band signal from low band radiating elements projecting forward of the grid pattern 305g. In some embodiments, at least part of a PIM shield 300′, 2300′ can comprise an FSS 305 provided as a single layer of sheet metal providing the grid pattern 305g with the unit cells and with the open centers or interiors devoid of metal. For further discussion of metal grids, see co-pending U.S. Provisional Application Ser. No. 63/254,446, the contents of which are hereby incorporated by reference as if recited in full herein.

Turning now to FIGS. 18A and 18B, a passive base station antenna 100 comprising the base station antenna housing 100h with the passive antenna assembly 190 is mounted to a first pole 10₁ and the active antenna 110 is mounted to a second pole 10₂ and is offset from the base station antenna housing 100h in both an X and Z direction. The base station antenna housing 100h can be partially enclosed by the PIM shield 2300′. The active antenna 110 includes a PIM shield 300, 300′ with an FSS 305. The PIM shield 2300, 2300′ can define a U-shaped cross-section with the open center of the U facing the front radome 111f. The PIM shield 300, 300′ can define a U-shaped cross-section with the open center of the U facing in an opposite direction (backward) to the forward direction that the PIM shield 2300, 2300′ faces, e.g., that faces the pole or rear of the active antenna 110.

The PIM shield 2300, 2300′ can have an FSS metal grid 305g adjacent to and facing or inside the rear 100r of the base station antenna housing 100h.

The right and left sides 2300s of the PIM shield 2300′ can comprise metal and project forward to merge flush with or behind the front radome 111f. The right and left sides 2300s can be provided as solid metal surfaces or FSS′.

FIG. 18A shows the active antenna 110 slightly behind the passive base station antenna 100. FIG. 18B shows the active antenna 110 in front of the passive base station antenna 100 and both mounted to a building as the mounting structure.

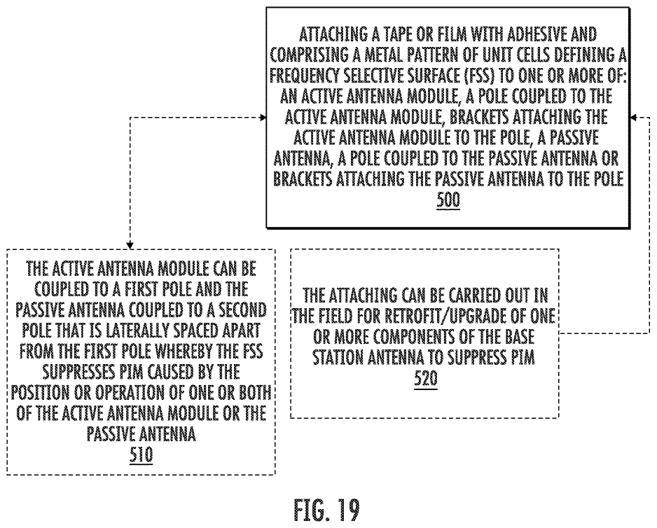

Referring to FIG. 19, example actions that can be used to provide PIM shields to a base station antenna site are shown. Tape or film with adhesive and comprising a metal pattern of unit cells defining a frequency selective surface (FSS) can be attached to one or more of: an active antenna, a pole coupled to the active antenna, brackets attaching the active antenna to the pole, a passive antenna, a pole coupled to the passive antenna or brackets attaching the passive antenna to the pole (block 500).

The active antenna 110 can be coupled to a first pole and the passive antenna assembly 190 can be coupled to a second pole that is laterally spaced apart from the first pole whereby the applied tape or film with the FSS suppresses PIM caused by the position or operation of one or both of the active antenna or the passive antenna (block 510).

The attaching can be carried out at a field site for to an installed active antenna and/or passive antenna of the base station antenna to suppress PIM (block 520).

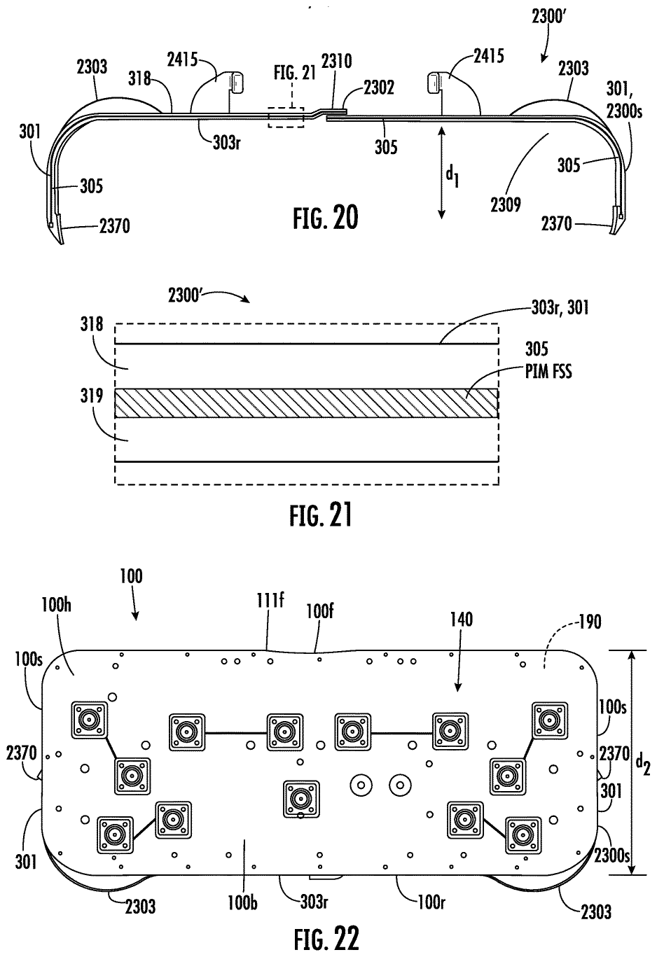

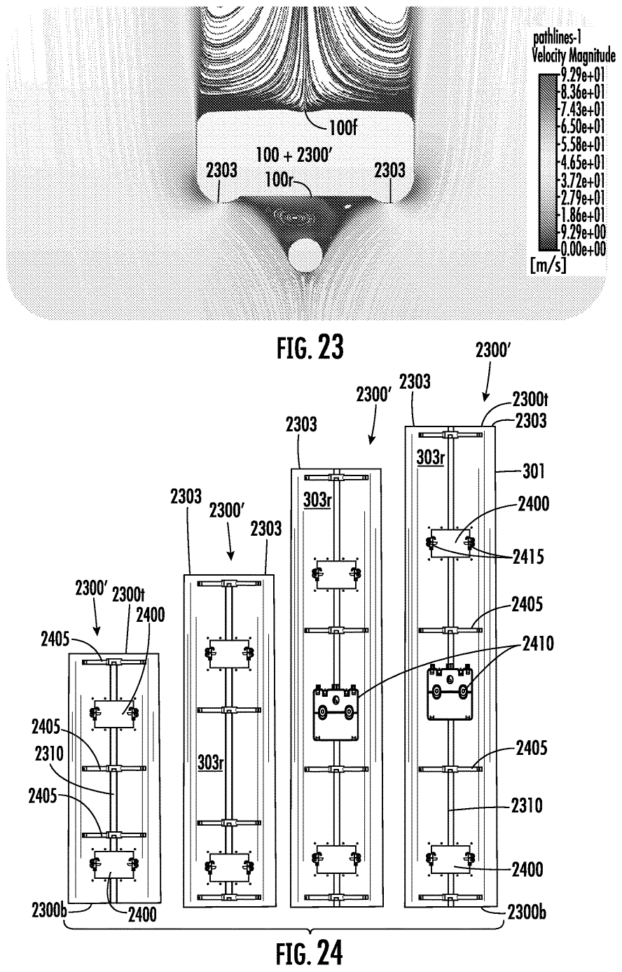

Turning now to FIGS. 20-31, similar to the embodiment discussed with respect to FIG. 14, the PIM shield 2300′ can be provided as a box-like structure with a rear wall 303r and sidewalls 301 and at least one surface with an FSS 305. The PIM shield 2300′ can be configured as a U-shape with the closed end of the U typically having a width that is greater than a length of the outer sides of the U to form a “short” U shape. As shown, the FSS 305 can extend across and along the rear wall 303r and the sidewalls 301, 2300s of the PIM shield 2300′. The sidewalls 301, 2300s of the PIM shield 2300′ can be sized and configured to extend forward to cover a portion of the sidewalls 100s of the base station antenna 100 (FIG. 22) so as to terminate behind the front 100f of the housing 100h, e.g., behind the front radome 111f.

Referring to FIG. 20, the PIM shield 2300′ can have side attachment features 2370 that are sized and configured to couple to the sidewalls 100s of the base station antenna housing 100h. The side attachment features 2370 can be configured to have gripping connectors that frictionally engage sidewalls 100s of the base station antenna 100.

The PIM shield 2300′ can have first and second laterally spaced apart curvilinear projections 2303 that project rearward (FIG. 22) from a rear 100r of the base station antenna housing 100h and that extend longitudinally along at least 50% of a length of the base station antenna housing 100h. The curvilinear projections 2303 can be arcuate as shown. The curvilinear projections 2303 can reduce a maximum wind load relative to a base station antenna housing 100h without a PIM shield 2300′ comprising the projections 2303. Based on a 498 platform B length, the maximum wind load without the PIM shield based on a computational model is measured as 755 versus the maximum wind load with the PIM shield 2303′ with the projections 2303 is 641 providing about a 15% reduction.

Referring to FIGS. 20 and 21, the PIM shield 2300′ can be provided as a multi-layer structure with the FSS 305 positioned between a first layer 318 and a second layer 319. The first layer 318 and the second layer 319 can provide a solid external surface protecting the FSS 305 and/or that provides an aesthetic cover layer(s). The first and second layers 318, 319 can be provided as a thin plastic suitable for radomes to cover both the inside surface and the outside surface of shield 2300′. The middle layer 305 can be provided as a metal grid, optionally made of sheet metal. However, the metal pattern provided by the middle layer 305 can also be printed or laminated onto at least one of the primary surfaces of at least one of the (plastic) layers 318, 319, but configured so that the metal pattern—back or front—of the PIM shield 2300′ is internal and thus not externally exposed.

As shown in FIG. 22, The PIM shield 2300′ can be thin and structurally semi-flexible with sufficiently rigid to be able to maintain its three-dimensional shape when unassembled but able to conformably attach to an outer surface(s) of the base station antenna housing 100h whereby the PIM shield 2300′ does not extend the width dimension of the base station antenna housing 100h.

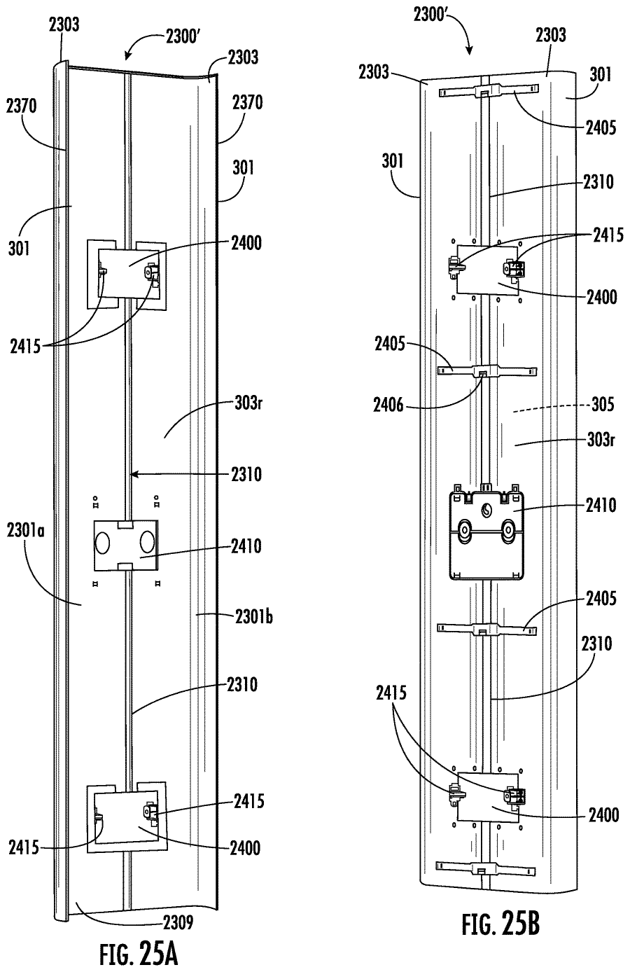

Referring to FIGS. 20, 24, 25A, 25B, the PIM shield 2300′ can comprise a plurality of longitudinally spaced apart windows 2400. The PIM shield 2300′ can have a top 2300t and a bottom 2300b and can also include a pair of bracket attachments 2415 on (laterally) opposing sides of at least one window 2400, shown as on opposing sides of upper and lower windows 2400. The PIM shield 2300′ can also comprise a cover 2410 that can extend over a window 2400 (FIG. 25A) under the cover 2410 for certain longer configurations of base station antennas 100. FIG. 24 shows that the PIM shield 2300′ can be provided in a plurality of different lengths with two of the four example lengths having the window cover 2410.

The PIM shield 2300′ can define a cavity 2309 (FIG. 20, 25A) that has a depth “d1” is sized and configured to receive a portion of the base station antenna housing 100h in a front to back direction of the base station antenna housing 100h, typically in a range of 10%-80% of a Z dimension “d2” of the base station antenna housing 100h (FIG. 22), shown as about 50% in FIG. 22.

The bracket attachments 2415 can project in a rearward direction away from and behind the rear surface 100r of the base station antenna housing 100h when the PIM shield 2300′ is positioned about the base station antenna 100 (FIGS. 26A, 26B). As shown in FIGS. 26A-26D, the bracket attachments 2415 can be configured to couple to mounting brackets 115 extending from the rear 100r of the base station antenna 100 to attach to a mounting structure 10, such as a pole.

FIG. 25A illustrates that a frame 2416 can be provided about the windows 2400 having the bracket attachments 2415 to provide structural reinforcement.

The PIM shield 2300′ can be provided as a unitary body. The PIM shield 2300′ can be provided as a plurality of body parts that can be attached together and/or to the base station antenna 100.

Referring to FIGS. 24, 25A, 25B and 26A-26D, the PIM shield 2300′ can be provided as a first body segment 2301a and a second body segment 2301b that are matably attachable. The first and second body segments 2301a, 2301b mate to define a longitudinally extending center seam 2310. The center seam 2310 may be configured so that longitudinally extending inner edge portions of the first and second body segments 2301a, 2301b overlap with one inner edge portion bent rearward at an angle to form a laterally extending overlapping lip 2302 (FIG. 20). The first and second body segments 2301a, 2301b can have a plurality of laterally extending supports 2405 that are longitudinally spaced apart. Pairs of the respective laterally extending supports 2405 can attach together. The bracket attachments 2405 can attach to the brackets 115 attached to the base station antenna housing 100h.

Turning now to FIGS. 26A-26D, an example installation sequence is shown. For field retrofit or upgrade, existing base station antennas 100 can be mounted to a target mounting structure 10 such as a pole via brackets 115. The first and second body segments 2301a, 2301b of the PIM shield 2300′ can be provided and lifted into position separately or concurrently (FIG. 26A). At least one laterally extending support 2405 of the first and second body segments 2301a, 2301b can be attached together. The bracket attachments 2415 can couple to an adjacent bracket 115 inside the window 2400.

A medial component 118 can be exposed through a medial window 2400 of the PIM shield 2300′ and a cover 2410 can be configured to extend over and across the window 2400 and medial component 118 (compare FIGS. 26B/C and 26D) to reduce/eliminate energy leakage.

A window 2400 of the PIM shield 2300′ can extend about a respective mounting bracket 115 and cooperating pairs of the bracket attachments 2405 can attach to a respective mounting bracket 115.

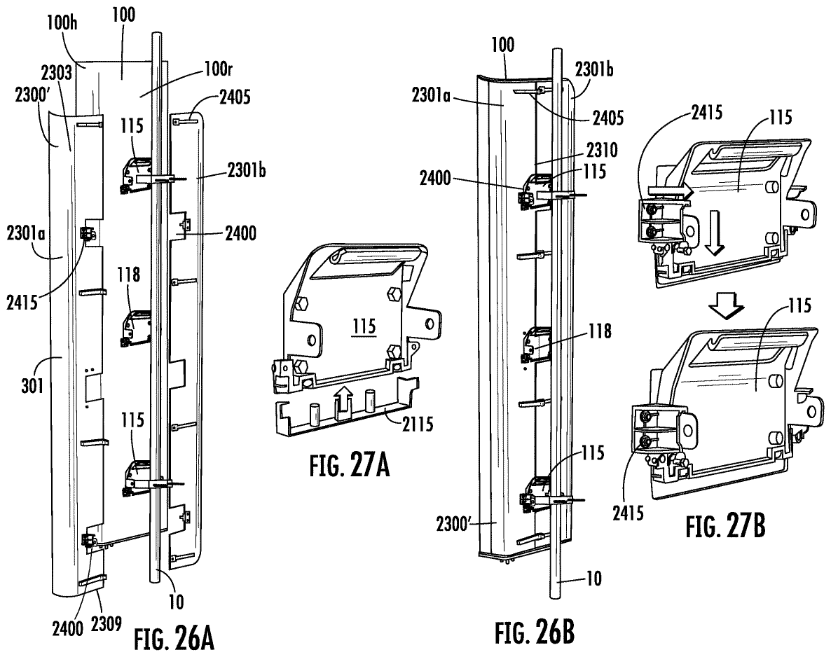

As shown in FIG. 27A, in some embodiments, a supplemental bracket 2115 can be attached to the mounting bracket 115 before assembling the PIM shield 2300′ to the base station antenna housing 100h. This supplemental bracket 2115 may provide a hard stop locator and can be particularly suitable for retrofit uses. However, it is noted that the mounting bracket 115 may be configured to provide the PIM shield attachment features without requiring a separate supplemental bracket (not shown).

FIG. 27B shows that the bracket attachments 2415 can be slid laterally inward, then downwardly (indicated by arrows) to the assembled position. The bracket attachments 2415 can have a projecting channel 2415c that has a open cavity that faces downward to contact a tab 115t of the mounting bracket 115.

FIG. 27C shows that at least one fastener 2117 can be used to affix a respective bracket attachment 2415 to the bracket 115. FIG. 27C shows that a fastener 2406 can be used to affix pairs of the laterally extending supports together.

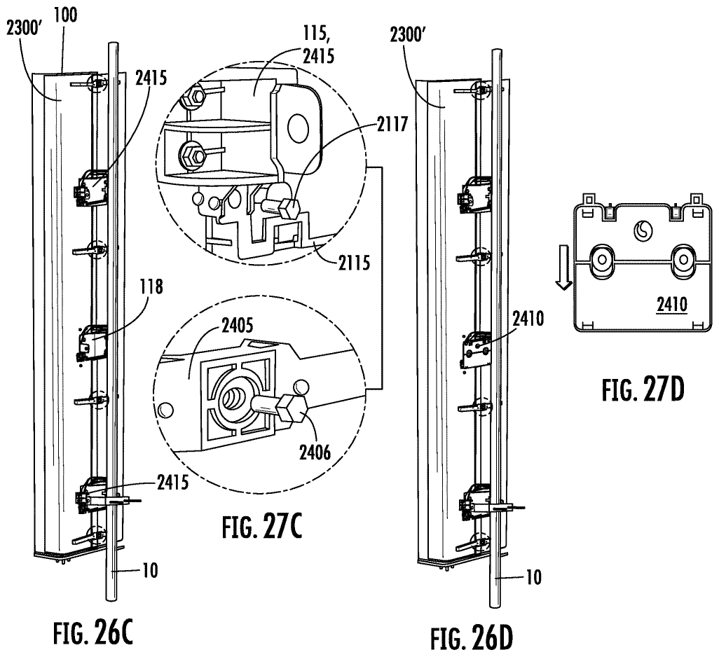

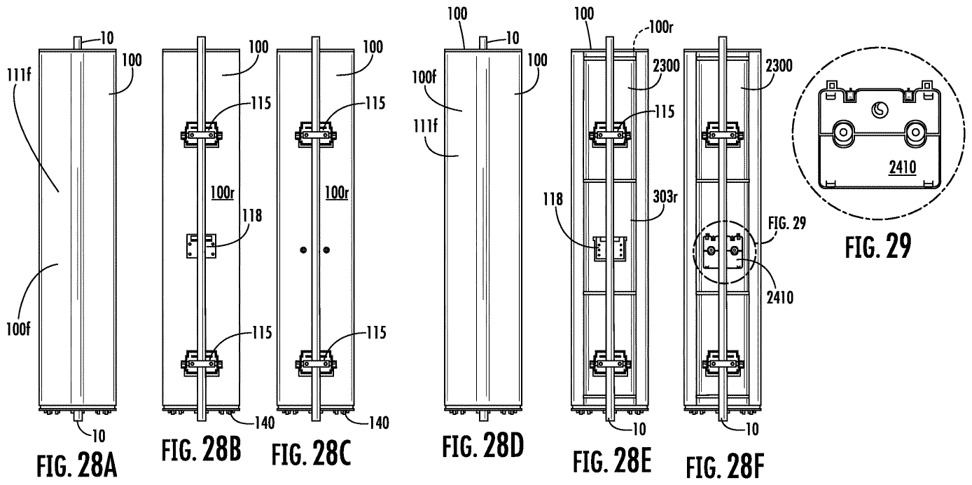

FIGS. 28A-28C show an example base station antenna 100 mounted to a target mounting structure 10 (e.g., a pole). The rear 100r of the base station antenna 100 faces and is adjacent the target mounting structure. FIGS. 28D-28E show the same views of the base station antenna shown in FIGS. 28A-28C but show that base station antenna 100 with the PIM shield 2300′. FIG. 29 shows the optional cover 2410 over medial component 118.

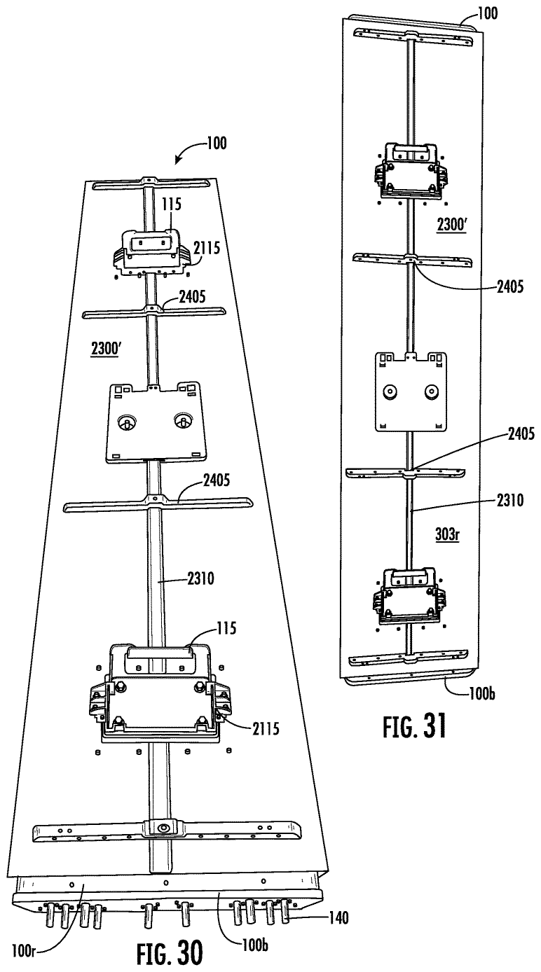

FIGS. 30 and 31 show a rear 100r of the base station antenna 100 inside the PIM shield 2300′ with the RF ports 140 exposed at a bottom 100b of the base station antenna 100.

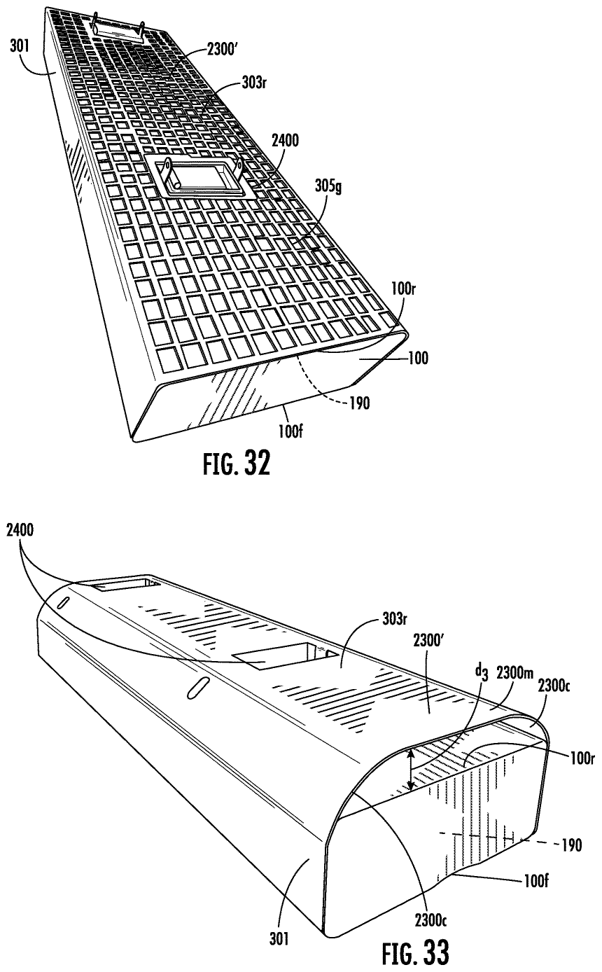

FIG. 32 shows another embodiment of the PIM shield 2300′ with the (metal) grid 305g of the FSS 305 externally exposed.

FIG. 33 shows another embodiment of the PIM shield 2300′ with windows 2400 and the rear 303r extending a distance “d₃” from the rear 100r of the base station antenna 100, shown with curved corners 2300c that extend laterally to merge into a medial section 2300m that can be parallel to the rear surface 100r of the base station antenna housing 100h. The distance d3 can be in a range of 0.10 inches to 2 inches. The left and right sidewalls of the PIM shield 2300′ can abut or be very closely spaced apart from the sidewalls 100s of the base station antenna 100.

As discussed above, the PIM shield 2300′ can include different patterns of FSS 305 along its length and/or across its width, such as along the rear surface 303r and/or sidewalls 301.

The FSS 305 can comprise a grid pattern with grid cells of any suitable geometry and/or substrate with shaped metal patches of any suitable geometry.

In some embodiments, at least part of the FSS 305 of the PIM shield 300′ of the active antenna 110 and/or the PIM shield 2300′ of the base station antenna housing 100h can be provided by a sheet or sheets of metal that is/are stamped, punched, acid etched, or otherwise formed to provide a grid pattern 305g. The grid pattern 305g can be configured to have closed or open unit cells 1305 (FIG. 17) of any suitable geometry.

The FSS 305 can be configured to block or reflect low band RF energy and allow higher band energy to propagate therethrough.

Embodiments of the invention provide PIM shields that can be integrated into OEM new builds of antenna components.

Embodiments of the invention provide PIM shields that can be provided as an aftermarket product/kit that can be used to provide PIM protection at field sites of base station antennas.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.)

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The term “about” used with respect to a number refers to a variation of +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. An antenna, comprising:
a housing with an external radome;
a multi-column array of radiating elements in the housing; and
a passive inter-modulation distortion (“PIM”) shield that is on, in and/or positioned about at least part of the housing, wherein the PIM shield comprises a frequency selective surface (FSS).

2. (canceled)

3. The antenna of claim 1, wherein the PIM shield comprises a first longitudinally extending body coupled to a second longitudinally extending body, wherein the first and second longitudinally extending bodies define a plurality of longitudinally extending windows, with at least one of the windows configured to receive a mounting bracket, and wherein the first and second longitudinally extending bodies each comprise a bracket attachment projecting rearward adjacent at least one of the windows.

4. The antenna of claim 1, wherein the PIM shield comprises a rear wall with first and second laterally spaced apart and rearwardly extending projections that extend longitudinally along at least a portion of a length of the passive antenna thereby providing a maximum wind load reduction.

5. (canceled)

6. The antenna of claim 1, wherein the FSS is provided by a flexible film or tape comprising a metal pattern of unit cells and adhesive that is applied to the radome.

7. The antenna of claim 1, wherein the antenna is an active antenna, and wherein the FSS is arranged to cover at least part of rearwardly extending sidewalls of the housing and the radome.

8. The antenna of claim 1, wherein the antenna is an active antenna, and wherein the FSS is arranged to cover an outer front surface of the radome.

9. The active antenna of claim 1, wherein the FSS is arranged to cover an inner surface of the radome.

10. The antenna of claim 1, wherein the FSS has a first pattern unit configuration at a first location and a second pattern unit configuration at a second location, and wherein the first pattern unit configuration is different than the second pattern unit configuration.

11. The antenna of claim 1, wherein the antenna is an active antenna comprising radio circuitry, and wherein the PIM shield comprises a longitudinally and laterally extending front wall that resides in front of the housing and comprise the FSS, and wherein the PIM shield further comprises right and left sidewalls that extend rearwardly about right and left side walls of the housing.

12. The antenna of claim 11, wherein the right and left sidewalls are metal and devoid of the FSS.

13. The antenna of claim 11, wherein the right and left sidewalls also comprise the FSS.

14. The antenna of claim 1, wherein the antenna is an active antenna, and wherein the PIM shield is a concealment shroud that surrounds the active antenna.

15. The antenna of claim 1, wherein the antenna with the PIM shield is an active antenna and is spaced apart from a passive base station antenna.

16. The antenna of claim 15, wherein the active antenna projects forward of the passive base station antenna.

17. The antenna of claim 1, wherein the PIM shield is provided by a structure that at least partially encloses the housing.

18. The antenna of claim 1, wherein the PIM shield is provided by a box with at least one wall comprising the FSS and that at least partially encloses the housing.

19. The antenna of claim 1, wherein the PIM shield encloses the housing and optionally at least part of a pole attached to the antenna.

20. (canceled)

21. The antenna of claim 1, wherein the FSS comprises a metal pattern provided by a flexible film with an adhesive configured to attach to target surfaces of the housing.

22-23. (canceled)

24. An antenna system comprising:
a passive antenna comprising a front radome and a rear wall;
a plurality of columns of first radiating elements configured for operating in a first operational frequency band, each column of first radiating elements comprising a plurality of first radiating elements arranged in a longitudinal direction; and
a passive intermodulation (PIM) shield comprising a frequency selective surface (FSS) extending behind and across the rear wall for at least part of a length of the passive antenna, wherein the FSS is configured to reflect, absorb or block electromagnetic waves within the first operational frequency band and pass electromagnetic waves at a higher frequency band.

25. (canceled)

26. The antenna system of claim 24, further comprising an active antenna, wherein the active antenna comprises a housing with a radome, a frequency selective surface (FSS) providing a PIM shield, and a plurality of columns of second radiating elements configured for operating in a second operational frequency band that is different from and does not overlap with the first operational frequency band, and wherein the second operational frequency band is higher than the first operational frequency band, and wherein the active antenna is offset from the passive antenna.

27. (canceled)

28. The antenna system of claim 24, wherein the PIM shield of the passive antenna is provided by a U-shaped structure, and wherein the rear wall is inside the U-shaped structure and an open end of the U faces the front radome of the passive antenna.

29. The antenna system of claim 24, wherein the PIM shield comprises a U-shaped structure with the rear wall of the passive antenna inside the U-shaped structure adjacent the closed end thereof and with an open end of the U-shaped structure facing the front radome.

30-44. (canceled)
